(19) United States
(12) Patent Application Publication
(10) Pub. No.: US 2010/0122462 A1
(43) Pub. Date: May 20, 2010

(54) Skin Engaging Member for Razor Cartridge

(76) Inventors: Thilivhali Tshikovhi Ndou, Framingham, MA (US); Neville Sonnenberg, Newton, MA (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/271,287

(22) Filed: Nov. 14, 2008

(51) Int. Cl. B26B 21/40; B26B 21/00

(52) U.S. Cl. 30/41; 30/34.05; 30/50

(57) ABSTRACT

The present invention is directed to a skin engaging member in the form of a narrow elongated strip of dimensions suitable for placement on a razor cartridge. The skin engaging member includes a first uppermost erodible layer, a second erodible layer positioned below the first layer and a third erodible layer positioned below the second layer. The first layer has a first color and a first thickness dimension. The second layer has a second color different from said the color and a second thickness dimension that is less than the first thickness dimension. The third layer has a third color different from the first color and the second layer and has a third thickness dimension.

### FIELD OF THE INVENTION

The present invention relates to a skin engaging member or shaving aid strip for a razor cartridge.

### BACKGROUND OF THE INVENTION

In shaving systems of the wet shave type, factors such as the frictional drag of the razor across the skin, the force needed to sever hairs, and irritation of pre-existing skin damage can create a degree of shaving discomfort. Discomfort, and other problems accompanying wet shaving systems, can be alleviated by the application of shaving aids to the skin. Shaving aids may be applied prior to, during, or after shaving. A number of problems accompany the use of pre- and post-applied shaving aids. Pre-applied-shaving aids can evaporate or can be carried away from the site of application by repeated strokes of the razor. Post-applied-shaving aids are not present on the skin during shaving and thus their application may be too late to prevent an unwanted affect. Both pre-applied and post-applied shaving aids add additional steps to the shaving process.

Proposals have been made to incorporate a shaving aid e.g., lubricant, whisker softener, razor cleanser, medicinal agent, cosmetic agent or combination thereof, into a razor, e.g., by depositing a shaving aid in a recess on the razor, by incorporating a shaving aid directly into one or more molded polymeric components of the razor, by adhesively securing a shaving aid composite to the razor, and by use of a mechanical connection between a shaving aid composite and the razor. A water-soluble shaving aid, e.g., polyethylene oxide, has been mixed with a water-insoluble material, e.g., a polystyrene polymer, to form an insoluble polymer/soluble skin engaging member also known as a shaving aid strip, a shaving aid composite, or a lubricating strip. The skin engaging member has been mounted on razor and shaving cartridge structures, adjacent the shaving edge or edges, of single or multiple blade shaving systems. Upon exposure to water, the water-soluble shaving aid leaches from the skin engaging member onto the skin.

One problem associated with razor cartridges is that a user has no indication as to when the razor cartridge is nearing the end of its' optimal shave performance and should be replaced. One solution to this problem has been to utilize the skin engaging member or lubricating strip to provide an indication or signal to the user that the cartridge has reached the end of its' optimal shave performance and should be replaced. Such solutions include the use of a two colored lubrication strip. As the user shaves the lubrication member wears away. Typically, in two color systems one of the layers, e.g., the first layer which may be colored blue, is positioned to wear away first thus exposing the second layer which has a different color, e.g., white, than the first layer. This provides an indication to the user that the razor cartridge should be replaced.

One problem associated with the two color lube strip indicators is that they do not provide the user with a pre alert or pre indication that the razor cartridge is about to reach the end of its' optimal shave performance. Two color indicator strips distinguish only between an optimal shave performance and a sub-optimal shave performance. There is a need to provide the user with an intermediate indication that the razor cartridge will soon reach the end of its optimal shave performance giving the user ample time to acquire and/or locate a new replacement cartridge.

### SUMMARY OF THE INVENTION

The present invention is directed to a skin engaging member in the form of a narrow elongated strip of dimensions suitable for placement on a razor cartridge. The skin engaging member comprises a first uppermost layer comprising an erodible skin engaging layer of a first color. The first layer has a first thickness dimension. The skin engaging member comprises a second layer positioned below the first layer comprising an erodible skin engaging layer of a second color different from the first color. The second layer has a second thickness dimension that is less than the first thickness dimension. The skin engaging member comprises a third layer positioned below the second layer comprising an erodible skin engaging layer of a third color different from the first color and the second color. The third layer has a third thickness dimension.

The first color is preferably green. The second color is preferably yellow. The third color is preferably red.

Preferably, the first, second and third layers each comprise a solid polymeric material. Preferably, the first, second and third layers each comprise a water-soluble polymer and a water-insoluble polymer.

The skin engaging member may further comprise a fourth layer positioned between the second layer and the third layer. The fourth layer preferably has a color different from the color of the second layer. The fourth layer is preferably white.

During shaving the first layer erodes exposing the second layer to provide a color change that signals to a user that the razor cartridge is approaching a time to be replaced. The second layer erodes during shaving exposing the third layer to provide a color change that signals to a user that the razor cartridge should be replaced.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings.

FIG. 1 is a perspective view of a razor cartridge which includes a skin engaging member of the present invention.

FIG. 2 is a sectional view taken along line 2-2 of FIG. 1.

FIG. 3 is a perspective view of the skin engaging member included in the razor cartridge depicted in FIG. 1.

FIG. 4 is a side elevation view of the skin engaging member of FIG. 3.

FIG. 5 is a sectional view of a razor cartridge identical to that of FIG. 2, but depicting a second embodiment of the skin engaging member of the present invention.

FIG. 6 is a perspective view of the skin engaging member included in the razor cartridge depicted in FIG. 5.

FIG. 7 is a side elevation view of the skin engaging member of FIG. 6.

### DETAILED DESCRIPTION OF THE INVENTION

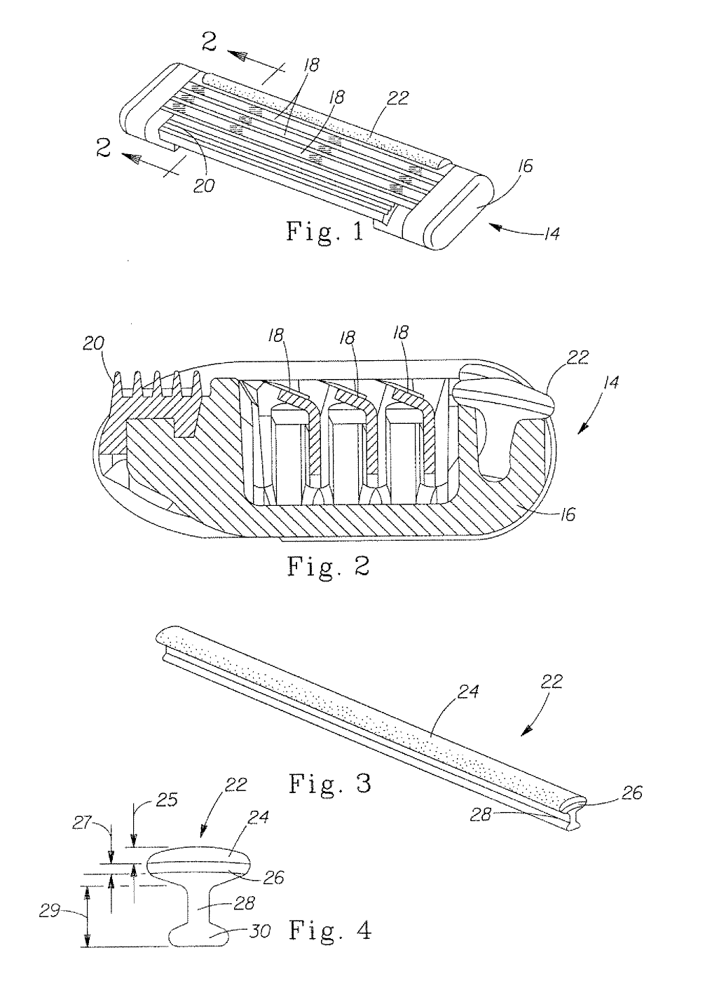

Referring to FIGS. 1, and 2 the razor cartridge 14 includes housing 16, which carries three blades 18, a finned elastomeric guard 20, and a skin engaging member or shaving aid strip 22 located on a skin-engaging portion (in this case the cap) of the cartridge 14. While the razor cartridge is shown with three blades 18, the cartridge may include two, three, four, five, six blades, etc. The skin engaging member 22 is in the form of a narrow elongated strip of dimensions suitable for placement on a razor cartridge. The skin engaging member 22 may be about 2.5 cm to about 3.7 cm in length, and about 0.15 cm to about 0.35 cm in width. The skin engaging member 22 is locked in an opening in the rear of the cartridge 14. The skin engaging member may be secured to cartridge 14 by other known methods such as ultrasonic welding or gluing. While shown at the rear portion of this particular razor cartridge, the skin engaging member may be located at any skin-engaging portion of the cartridge and may be fabricated in any size or shape deemed appropriate. For example, the skin engaging member can be incorporated into razor cartridges such as the Fusion®, Venus®, Mach 3®, Sensor Excel®, Atra Plus® and Custom Plus® razors sold by The Gillette Company, as well as in other commercial razor cartridges.

Referring to FIGS. 3 and 4, skin engaging member 22 includes a first exposed uppermost lengthwise-extending erodible skin engaging layer or portion 24, a second lengthwise-extending erodible skin engaging layer or portion 26 positioned below the first layer 24, and a third lengthwise-extending erodible skin engaging layer or portion 28 positioned below the second layer 26. The second layer 26 preferably extends under the first layer 24 and provides support for first layer 24. The third layer 28 preferably extends under the second layer 26 and provides support for the second layer 26. The boundary between respective layers may approximate a plane as shown. However, the boundary between respective layers may approximate other shapes such as curvilinear, arcuate either convex or concave. Third layer 28 also includes connecting portion 30 which serves to lock the skin engaging member into a mating receiving portion of the cartridge.

Each layer or portion of the skin engaging member or shaving aid strip 22 preferably comprises a solid polymeric material. Each layer of the skin engaging member 22 preferably comprises a lubricious water-soluble polymer as the main shaving aid and a water-insoluble polymer to serve as a matrix in which the water-soluble polymer is dispersed. A layer having a greater amount of water-soluble polymer will wear at a faster rate or more quickly than a layer with a lower amount of water-soluble polymer, all other things being equal. Preferably, the second layer will comprise a greater amount of water-soluble polymer in percent by weight than the first layer. This structure allows the second layer to wear at a faster rate than the first layer during shaving. The third layer which acts to hold the skin engaging member in place within the cartridge and provides support for the first and second layers preferably comprises a lesser amount of water-soluble polymer by weight than the second layer.

Preferably, the first layer or portion 24 will comprise about 10% to about 40%, more preferably about 20% to about 35%, by weight water-insoluble polymer, and about 50% to about 80%, more preferably about 55% to about 75%, by weight lubricious water-soluble polymer. The second layer or portion 26 will preferably comprise about 0% to about 30%, more preferably about 10% to about 25%, by weight water-insoluble polymer, and about 65% to about 95%, more preferably about 70% to about 90%, by weight lubricious water-soluble polymer. Preferably, the third layer or portion 28 will comprise about 20% to about 60%, more preferably about 25% to about 40%, by weight water-insoluble polymer, and about 50% to about 85%, more preferably about 55% to about 75%, by weight lubricious water-soluble polymer.

Typical lubricious water-soluble polymers include polyethylene oxide, polyvinyl pyrrolidone, polyacrylamide, modified hydroxyalkyl cellulose, polyvinyl imidazoline, polyvinyl alcohol, polysulfone and polyhydroxyethylmethacrylate. The preferred lubricious water-soluble polymer is polyethylene oxide. The more preferred polyethylene oxides generally are known as POLYOX (available from Union Carbide Corporation) or ALKOX (available from Meisei Chemical Works, Kyoto, Japan). These polyethylene oxides will preferably have molecular weights of about 100,000 to 8 million daltons, most preferably about 300,000 to 5 million daltons. It is preferred to use a blend of polyethylene oxides, typically a blend having at least one polyethylene oxide having a molecular weight in the range of 100,000 to 500,000 and at least one polyethylene oxide having a molecular weight in the range of 3 million to 8 million. The most preferred polyethylene oxide comprises a blend of about 40% to 80% by weight of polyethylene oxide having an average molecular weight of about 5 million (e.g. POLYOX COAGULANT) and about 60% to 20% of polyethylene oxide having an average molecular weight of about 300,000 (e.g. POLYOX WSR-N-750). A 60:40 blend of these two polyethylene oxides (5 million: 300,000) is especially preferred.

Suitable water-insoluble polymers which can be used include polyethylene, polypropylene, polystyrene, butadiene-styrene copolymer (e.g. medium and high impact polystyrene), polyacetal, acrylonitrile-butadiene-styrene copolymer, ethylene vinyl acetate copolymer, polyurethane and blends thereof such as polypropylene/polystyrene blend or polystyrene/impact polystyrene blend. The more preferred water-insoluble polymer is polystyrene, preferably a general purpose polystyrene, such as NOVA C2345A, or a high impact polystyrene (i.e. polystyrene-butadiene), such as NOVA 5410 or Total 975E. The strip or any portion should contain a sufficient quantity of water-insoluble polymer to provide adequate mechanical strength, both during production and use.

The second layer or portion 26 of the shaving aid strip 22 may also include a material which allows it to wear more quickly than the first layer or portion 24 and/or which facilitates the inclusion of relatively high levels of water-soluble polymer. One such material is polycaprolactone, as described in copending application U.S. Ser. No. 09/506,628 (Docket No. 8070) filed on Feb. 18, 2000. Preferably, the polycaprolactone will be included in an amount of about 1% to about 10% by weight. Polycaprolactones are available from PERSTOP/SOLVAY under the name CAPA® polymers (e.g., 6100, 6505, 65065 and 6800). Preferably, the polycaprolactone will have a molecular weight between about 1000 and about 80,000 daltons, more preferably between about 30,000 and 60,000 daltons, and most preferably about 50,000 daltons.

The shaving aid strip, or any portion, also may contain other conventional shaving aid ingredients, such as low molecular weight water-soluble release enhancing agents such as polyethylene glycol (MW<10,000, e.g., 1-10% by weight PEG-100), water-swellable release enhancing agents such as cross-linked polyacrylics (e.g., 2-7% by weight), antioxidants, preservatives, botanical oils, vitamin E, aloe, cooling agents, essential oils, beard softeners, astringents, medicinal agents, mineral oil, etc.

The first layer 24 comprises a first color. The first color is preferably green. The first layer 24 is preferably colored green with a green dye or pigment such as phthalocyanine pigment green 7. The second layer 26 comprises a second color which is different from the first color. The second color is preferably yellow. The second layer 26 is preferably colored yellow with a yellow dye or pigment such as benzimidazolone pigment yellow 180. The third layer 28 comprises a third color which is different from the first color and the second color. The third color is preferably red. The third layer 28 is preferably colored red with a red dye or pigment such as DPP pigment red 254.

A wear indicating effect is produced when the first, second and third layers are made of disparately colored materials (e.g. green colored first layer, yellow colored second layer and red colored third layer). Upon use, the first layer 24 at the skin engaging surface is typically worn off (or eroded) through use. With sufficient use, the second layer 26 is exposed, thus providing the user with an indication via the color change from the first color to the second color that the razor cartridge and/or skin engaging surface are nearing the end of their optimal effective life approaching a time to be replaced. This indication provides the user with ample time to acquire and/or locate a new replacement cartridge. With further use, the second layer 26 is worn off (or eroded) through use. With sufficient use, the third layer 28 is exposed, thus providing the user with an indication via the color change from the second color to the third color that the razor cartridge and/or skin engaging surface have reached the end of their optimal effective life or optimal performance and should be replaced.

The colorants may be released by leaching or abrasion. A layer may contain, for example, between about 0.1% and about 5.0% (preferably between about 0.5% and 3%) colorant by weight.

The first layer 24 has a first thickness dimension 25. Preferably the first thickness dimension 25 is from about 0.2 to about 0.6 mm. The second layer 26 has a second thickness dimension 27. Preferably, the second thickness dimension 27 is less than the first thickness dimension 25. Preferably, the second thickness dimension 27 is from about 0.15 to about 0.5 mm. The third layer 28 has a third thickness dimension 29. Preferably, the third thickness dimension 29 is greater than the second thickness dimension 27. Preferably, the third thickness dimension 29 is from about 1.0 to about 3.0 mm.

When the first layer 24 is thicker than the second layer 26, it will tend to wear away at a slower rate than second layer 26. This slower wear rate provides lubrication over a longer period of time. At the same time, second layer 26 wears more quickly or at a faster rate than the first layer 24 and thus provides an indication to the user that the end of the optimal shave performance of the cartridge is quickly approaching. The effect is similar to that of a traffic light where the traffic light is lit green for a relatively longer period of time and lit yellow for a relatively shorter period of time compared to that of the green light.

Similarly, when the first layer 24 has a lesser amount of water-soluble polymer than the second layer 26, it will tend to wear away at a slower rate than second layer 26. This slower wear rate provides lubrication over a longer period of time. At the same time, second layer 26 wears more quickly or at a faster rate than the first layer 24 as it has a greater amount of water-soluble polymer than the first layer 24 and thus provides an indication to the user that the end of the optimal shave performance of the cartridge is quickly approaching. The effect is similar to that of a traffic light where the traffic light is lit green for a relatively longer period of time and lit yellow for a relatively shorter period of time compared to that of the green light.

Skin engaging members of the present invention may be fabricated by any appropriate method, including injection molding and extrusion, the latter being preferred. All of the components of the strip are blended prior to molding or extrusion. For best results, it is preferred that the components are dry.

The skin engaging member may be formed by combining three extruders via a three input transition die assembly. The first layer may be delivered through a ¾ inch diameter Brabender PL2200 Plasti-corder, with a pressure of about 2500-8000 psi, a rotor speed of about 12 to 25 rpm, and a temperature of about 245°-380° F. The extruder may be ½ to 1 inch in diameter. The second layer may be delivered through a 1 inch diameter Davis Standard with a pressure of about 6000-8000 psi, a rotor speed of about 9 to 20 rpm, and a temperature of about 190°-390° F. The extruder may be ½ to 1 inch in diameter. The extruder may be ½ to 1 inch in diameter. The third layer may be delivered through a 1.5 inch diameter Davis Standard with a pressure of about 2500-3500 psi, a rotor speed of about 10 to 20 rpm, and a temperature of about 290°-385° F. The extruder may be ¾ to 1.5 inch in diameter. The die assembly may be between about 350°-420° F. The feed throat sections for all three extruders may be cooled to about 62° F. The output speed may be between about 30 to 70 feet per minute.

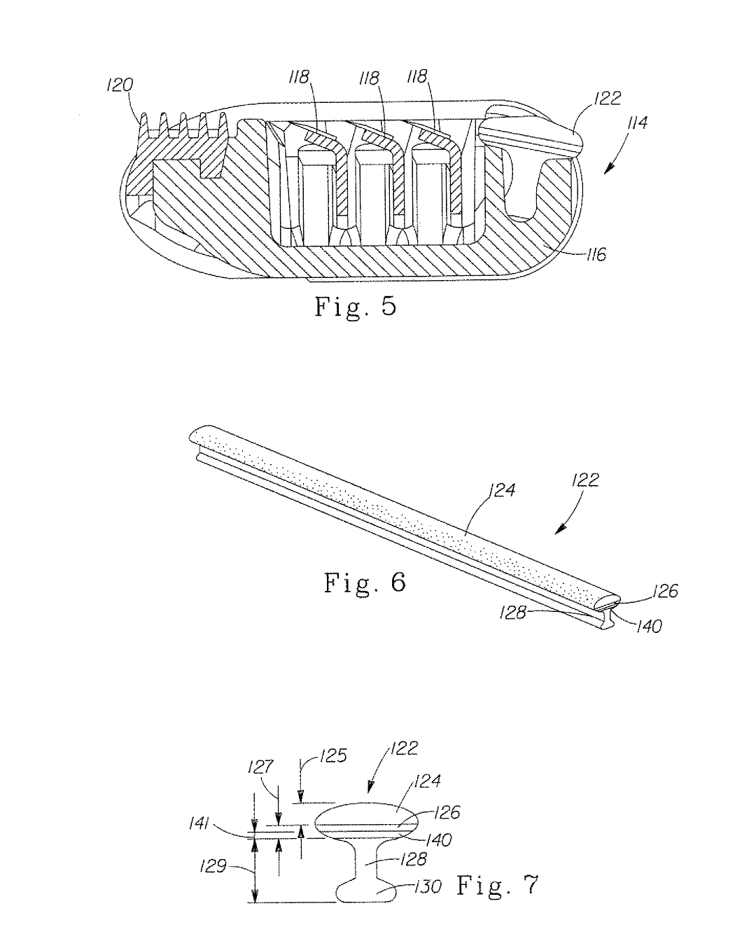

Referring now to FIG. 5 the razor cartridge 114 includes housing 116, which carries three blades 118, a finned elastomeric guard 120, and a skin engaging member or shaving aid strip 122 located on a skin-engaging portion (in this case the cap) of the cartridge 114. While the razor cartridge is shown with three blades, the cartridge may include two, three, four, five, six blades, etc. The skin engaging member 122 is in the form of a narrow elongated strip of dimensions suitable for placement on a razor cartridge. The skin engaging member 122 may be about 2.5 cm to about 3.7 cm in length, and about 0.15 cm to about 0.35 cm in width. The skin engaging member 122 is locked in an opening in the rear of the cartridge 114. The skin engaging member may be secured to cartridge 114 by other known methods such as ultrasonic welding or gluing. While shown at the rear portion of this particular razor cartridge, the skin engaging member may be located at any skin-engaging portion of the cartridge and may be fabricated in any size or shape deemed appropriate. For example, the skin engaging member can be incorporated into razor cartridges such as the Fusion®, Venus®, Mach 3®, Sensor Excel®, Atra Plus® and Custom Plus® razors sold by The Gillette Company, as well as in other commercial razor cartridges.

Referring to FIGS. 6 and 7, skin engaging member 122 includes a first exposed uppermost lengthwise-extending erodible skin engaging layer or portion 124, a second lengthwise-extending erodible skin engaging layer or portion 126 positioned below the first layer 124, a third lengthwise-extending erodible skin engaging layer or portion 128 positioned below the second layer 126 and a fourth lengthwise-extending erodible skin engaging layer or portion 140 positioned between the second layer 126 and the third layer 128. The second layer 126 preferably extends under the first layer 124 and provides support for first layer 124. The fourth layer 140 preferably extends under the second layer 126 and provides support for the second layer 126. The third layer 128 preferably extends under the fourth layer 140 and provides support for the fourth layer 140. The boundary between respective layers may approximate a plane as shown. However, the boundary between respective layers may approximate other shapes such as curvilinear, arcuate either convex or concave. Third layer 128 also includes connecting portion 130 which serves to lock the skin engaging member into a mating receiving portion of the cartridge.

Each layer or portion of the skin engaging member or shaving aid strip 122 preferably comprises a solid polymeric material. Each layer of the skin engaging member 122 preferably comprises a lubricious water-soluble polymer as the main shaving aid and a water-insoluble polymer to serve as a matrix in which the water-soluble polymer is dispersed. A layer having a greater amount of water-soluble polymer will wear at a faster rate or more quickly than a layer with a lower amount of water-soluble polymer, all other things being equal. Preferably, the second layer will comprise a greater amount of water-soluble polymer in percent by weight than the first layer. This structure allows the second layer to wear at a faster rate than the first layer during shaving. The third layer which acts to hold the skin engaging member in place within the cartridge and provides support for the first and second layers preferably comprises a lesser amount of water-soluble polymer by weight than the second layer.

Preferably, the first layer or portion 124 will comprise about 10% to about 40%, more preferably about 20% to about 35%, by weight water-insoluble polymer, and about 50% to about 80%, more preferably about 55% to about 75%, by weight lubricious water-soluble polymer. The second layer or portion 126 will preferably comprise about 0% to about 30%, more preferably about 10% to about 25%, by weight water-insoluble polymer, and about 65% to about 95%, more preferably about 70% to about 90%, by weight lubricious water-soluble polymer. The fourth layer or portion 140 will preferably comprise about 0% to about 30%, more preferably about 10% to about 25%, by weight water-insoluble polymer, and about 65% to about 95%, more preferably about 70% to about 90%, by weight lubricious water-soluble polymer. Preferably, the third layer or portion 128 will comprise about 20% to about 60%, more preferably about 25% to about 40%, by weight water-insoluble polymer, and about 50% to about 85%, more preferably about 55% to about 75%, by weight lubricious water-soluble polymer.

Water-soluble polymers and water-insoluble are preferably the same as those mentioned with respect to the embodiment shown in FIGS. 1-4.

The second layer 126 and the fourth layer 140 may also include a material which allows them to wear more quickly than the first layer or portion 124 and/or which facilitates the inclusion of relatively high levels of water-soluble polymer. Suitable materials are the same as those mentioned with respect to the embodiment shown in FIGS. 1-4.

The shaving aid strip 122, or any portion, also may contain other conventional shaving aid ingredients as those mentioned above with respect to the embodiment shown in FIGS. 1-4.

The first layer 124 comprises a first color. The first color is preferably green. The first layer 124 is preferably colored green with a green dye or pigment such as phthalocyanine pigment green 7. The second layer 126 comprises a second color which is different from the first color. The second color is preferably yellow. The second layer 126 is preferably colored yellow with a yellow dye or pigment such as benzimidazolone pigment yellow 180. The third layer 128 comprises a third color which is different from the first color and the second color. The third color is preferably red. The third layer 128 is preferably colored red with a red dye or pigment such as DPP pigment red 254. The fourth layer 140 comprises a fourth color which is different from the second color. More preferably the fourth color is different from the first color, the second color and the third color. The fourth color is preferably white. The fourth layer 140 is preferably colored white with a white dye or pigment such as titanium dioxide.

A wear indicating effect is produced when the first, second, third and fourth layers are made of disparately colored materials (e.g. green colored first layer, yellow colored second layer, red colored third layer and white colored fourth layer). Upon use, the first layer 124 at the skin engaging surface is typically worn off (or eroded) through use. With sufficient use, the second layer 126 is exposed, thus providing the user with an indication via the color change from the first color to the second color that the razor cartridge and/or skin engaging surface are nearing the end of their optimal effective life approaching a time to be replaced. This indication provides the user with ample time to acquire and/or locate a new replacement cartridge. The fourth layer which in the preferred embodiment is white helps to provide a greater contrast for the yellow second layer with the red third layer. The addition of the white fourth layer between the yellow second layer and the red third layer helps the yellow second layer stand out and not be washed out or overpowered by the red third layer. With further use, the second layer 126 is worn off (or eroded) through use. With further use the fourth layer 140 is worn off (or eroded) through use. With sufficient use, the third layer 128 is exposed, thus providing the user with an indication via the color change from the second and fourth colors to the third color that the razor cartridge and/or skin engaging surface have reached the end of their optimal effective life or optimal performance and should be replaced.

The colorants may be released by leaching or abrasion. A layer may contain, for example, between about 0.1% and about 5.0% (preferably between about 0.5% and 3%) colorant by weight.

The first layer 124 has a first thickness dimension 125. Preferably the first thickness dimension 125 is from about 0.2 to about 0.6 mm. The second layer 126 has a second thickness dimension 127. Preferably, the second thickness dimension 127 is less than the first thickness dimension 125. Preferably, the second thickness dimension 127 is from about 0.15 mm to about 0.5 mm. The fourth layer 140 has a fourth thickness dimension 141. Preferably, the fourth thickness dimension 141 is from about 0.1 mm to about 0.3 mm. The third layer 128 has a third thickness dimension 129. Preferably, the third thickness dimension 129 is greater than the second thickness dimension 127. Preferably, the third thickness dimension 129 is from about 1.0 mm to about 3.0 mm.

When the first layer 124 is thicker than the second layer 126, it will tend to wear away at a slower rate than second layer 126. This slower wear rate provides lubrication over a longer period of time. At the same time, second layer 126 wears more quickly or at a faster rate than the first layer 124 and thus provides an indication to the user that the end of the optimal shave performance of the cartridge is quickly approaching. The effect is similar to that of a traffic light where the traffic light is lit green for a relatively longer period of time and lit yellow for a relatively shorter period of time compared to that of the green light. Similarly, the fourth layer 140 wears more quickly or at a faster rate than the first layer 124 and preferably more quickly or at a faster rate than the second layer 126.

Similarly, when the first layer 124 has a lesser amount of water-soluble polymer than the second layer 126, it will tend to wear away at a slower rate than second layer 126. This slower wear rate provides lubrication over a longer period of time. At the same time, second layer 126 wears more quickly or at a faster rate than the first layer 124 as it has a greater amount of water-soluble polymer than the first layer 124 and thus provides an indication to the user that the end of the optimal shave performance of the cartridge is quickly approaching. The effect is similar to that of a traffic light where the traffic light is lit green for a relatively longer period of time and lit yellow for a relatively shorter period of time compared to that of the green light.

Skin engaging member 122 may be fabricated by any appropriate method, including by the same methods as described with respect to skin engaging member 22.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A skin engaging member in the form of a narrow elongated strip of dimensions suitable for placement on a razor cartridge, said skin engaging member comprising
a first uppermost layer comprising an erodible skin engaging layer of a first color, said first layer having a first thickness dimension,
a second layer positioned below said first layer comprising an erodible skin engaging layer of a second color different from said first color, said second layer having a second thickness dimension, said second thickness dimension being less than said first thickness dimension, and
a third layer positioned below said second layer comprising an erodible skin engaging layer of a third color different from said first color and said second color, said third layer having a third thickness dimension.

2. The skin engaging member of claim 1, wherein said first color is green.

3. The skin engaging member of claim 1, wherein said second color is yellow.

4. The skin engaging member of claim 1, wherein said third color is red.

5. The skin engaging member of claim 1, wherein said first, second and third layers each comprise a solid polymeric material.

6. The skin engaging member of claim 1, wherein said first, second and third layers each comprise a water-soluble polymer and a water-insoluble polymer.

7. The skin engaging member of claim 1, further comprising a fourth layer positioned between said second layer and said third layer.

8. The skin engaging member of claim 7, wherein said fourth layer has a color different from the color of said second layer.

9. A skin engaging member in the form of a narrow elongated strip of dimensions suitable for placement on a razor cartridge, said skin engaging member comprising
a first uppermost layer comprising an erodible skin engaging layer of a first color, said first layer having a first thickness dimension,
a second layer positioned below said first layer comprising an erodible skin engaging layer of a second color different from said first color, said second layer having a second thickness dimension, said second thickness dimension being less than said first thickness dimension,
a third layer positioned below said second layer comprising an erodible skin engaging layer of a third color different from said first color and said second color, said third layer having a third thickness dimension, said third thickness dimension being greater than said second thickness dimension, and
said first layer eroding during shaving exposing said second layer to provide a color change that signals to a user that the razor cartridge is approaching a time to be replaced, said second layer eroding during shaving exposing said third layer to provide a color change that signals to a user that the razor cartridge should be replaced.

10. The skin engaging member of claim 9, wherein said first color is green.

11. The skin engaging member of claim 9, wherein said second color is yellow.

12. The skin engaging member of claim 9, wherein said third color is red.

13. The skin engaging member of claim 9, wherein said first, second and third layers each comprise a solid polymeric material.

14. The skin engaging member of claim 9, wherein said first, second and third layers each comprise a water-soluble polymer and a water-insoluble polymer.

15. The skin engaging member of claim 9, further comprising a fourth layer positioned between said second layer and said third layer.

16. The skin engaging member of claim 15, wherein said fourth layer has a color different from the color of said second layer.
